(19) United States
(12) Patent Application Publication
(10) Pub. No.: US 2003/0068425 A1
(43) Pub. Date: Apr. 10, 2003

(54) Steryl ester compositions

(76) Inventor: Anil Bhagwan Khare, Crystal, MN (US)

Correspondence Address: Jeffrey J. Skelton, P.O. Box 5624, Minneapolis, MN, 55440, US

(21) Appl. No.: 10/236,111

(22) Filed: Sep. 6, 2002

Related U.S. Application Data
(60) Provisional application No. 60/318,162, filed on Sep. 7, 2001.

(51) Int. Cl. A23D 7/00

(52) U.S. Cl. 426/601

(57) ABSTRACT

Steryl esters compositions are described that contain a steryl ester compound, wherein the sterol moiety is a phytosterol and the ester moiety is a blend of fatty acids that includes at least 80% oleic acid, as well as confectionary products containing such steryl esters.

### RELATED APPLICATIONS

The present application claims priority from and benefit of U.S. provisional application 60/318,162 filed Sep. 7, 2001.

### TECHNICAL FIELD

This invention relates to steryl esters, wherein the sterol moiety is a phytosterol and wherein the ester moiety is a blend of fatty acids that includes at least 80% oleic acid.

### BACKGROUND

Sterols are a class of steroids that contain a hydroxy group at the C3 position and a branched aliphatic chain of 8-10 carbon atoms at the C17 position. Bailey's Industrial Oil & Fat Products: General Applications, Vol. 1, pp. 402-403, John Wiley & Sons, Inc., New York, N.Y. (1996). Phytosterols, i.e., plant sterols, are natural products obtained as byproducts of vegetable oil processing. Stanols are hydrogenated derivatives of sterols. Plant sterols and stanols, which are structurally similar to cholesterol, reduce cholesterol absorption and serum cholesterol levels in subjects and are themselves poorly absorbed. Solubility of free plant sterols and stanols is limited in oils and/or fats, which reduces the usefulness of the free sterols and stanols in cholesterol-reducing food products. To increase solubility, the sterols and stanols are esterified with fatty acids. Such sterol or stanol fatty acid esters, however, often have poor physical characteristics (e.g., a broad melting profile) for incorporating into food products.

### SUMMARY

The present invention is based on the discovery that steryl esters that are produced using phytosterols and blends of fatty acids with a high oleic acid content have desirable melting profiles for food applications. More specifically, steryl esters of the invention are solid at room temperature and have a sharp melting point around body temperature, which is particularly useful for confectionary or other products where mouthfeel is an important feature.

In one aspect, the invention features a composition that includes a steryl ester, wherein the sterol moiety of the steryl ester is a phytosterol (e.g., a soy sterol or tall oil sterol) and the ester moiety of the steryl ester includes a blend of fatty acids, wherein the blend of fatty acids includes at least 80% oleic acid (e.g., 80 to 95% oleic acid). The steryl ester can have a differential scanning calorimetry (DSC) melting point of about 17° C. to about 35° C., e.g., about 25° C. to about 35° C. The steryl ester can include at least about 1% weight % (wt %) or 50 wt % of the composition. The composition further can include one or more components selected from the group consisting of sugar, flavorings, milk solids, emulsifiers, antioxidants, bulking agents, coloring agents, and preservatives.

The invention also features a confectionary product that includes a fat component. The fat component includes a steryl ester, wherein the sterol moiety of the steryl ester is a phytosterol and the ester moiety of the steryl ester is a blend of fatty acids, wherein the blend of fatty acids includes at least 80% oleic acid. The confectionary product further can include one or more components selected from the group consisting of sugar, flavorings, milk solids, emulsifiers, antioxidants, bulking agents, coloring agents, and preservatives. The flavorings can be selected from the group consisting of cocoa powder, cocoa mass, chocolate liquor, and vanilla. The emulsifiers can be selected from the group consisting of lecithin, synthetic phospholipids, sorbitan esters and the like.

In yet another aspect, the invention features a method for producing a steryl ester that includes transesterifying a blend of fatty acid esters (e.g., fatty acid methyl esters) and a phytosterol (e.g., soy sterol) to produce the steryl ester. The blend of fatty acid esters includes at least 80% oleic acid.

Unless otherwise defined, all technical and scientific terms used herein have the same meaning as commonly understood by one of ordinary skill in the art to which this invention belongs. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are only illustrative of the present invention and are not intended to limit the invention in any way.

Other features and advantages of the invention will be apparent from the following detailed description, and from the claims.

### DETAILED DESCRIPTION

The invention features steryl esters and compositions containing such steryl esters. The term “steryl ester” as used herein refers to a compound that contains a fatty acid linked to the C3 carbon of a phytosterol (see chemical structures below) via an ester bond. As described herein, steryl esters of the invention have enhanced oil solubility and improved melting characteristics as compared with steryl esters having a lower oleic acid content.

Steryl Esters

As described above, steryl esters of the invention contain a phytosterol moiety and an ester moiety. Phytosterols are found in various plant oils including tall oils (from pine trees) and oilseeds such as soy, safflower, sunflower, rapeseed, cottonseed, and peanut. In oilseeds, the most abundant phytosterols are sitosterol (˜52 to 89% of total sterols), campesterol (˜2 to 30% of total sterols), and stigmasterol (up to 26% of total sterols). The chemical structures of sitosterol, campesterol, and stigmasterol are provided below in formulas I and II.

### Formula I and Formula II

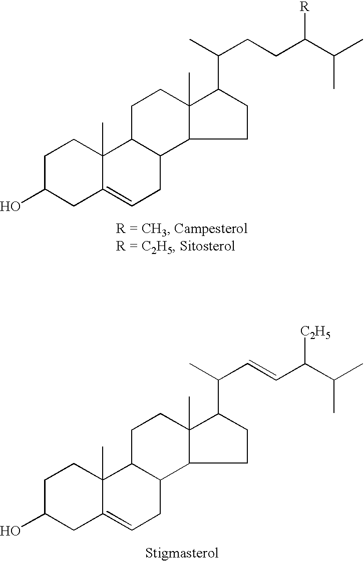

Phytosterols are typically recovered from deodorizer distillate, which is produced during deodorization or refining of vegetable oils or from tall oil. Individual, purified phytosterols, e.g., purified sitosterol or purified stigmasterol, are available commercially, as are blends of sterols, e.g., soy sterol containing β-sitosterol, stigmasterol, and campesterol and others. Soy sterols are particularly useful in the present invention. Sterols can be obtained as free sterols or as sterol glycosides, in which a sugar moiety is attached to the hydroxyl group of the sterol, or as sterol esters, in which the hydroxyl group is attached to a fatty acid.

The ester moiety of steryl esters of the present invention is a blend of fatty acids. Suitable blends of fatty acids include at least 80% oleic acid, e.g., 80% to 99%, 80% to 95%, 80% to 90%, or 82% to 92%, and, preferably, at least 90% oleic acid, e.g., 90% to 95% or 92% to 98% oleic acid. Such blends can be isolated from vegetable oils, and in particular, from high oleic acid canola oil and high oleic sunflower oil. Suitable canola oils are described, for example, in U.S. Pat. Nos. 5,861,187, 5,850,026, and 5,840,946. In addition, seeds of a canola plant line (line Q4275) that yield a canola oil having an oleic acid content greater than 80% have been deposited with the American Type Culture Collection under Accession No. 97569. High oleic sunflower oils having oleic acid contents of about 86% to about 92%, can be obtained from A. C. Humko, Memphis, Tenn. U.S. Pat. No. 4,627,192 describes a suitable high oleic acid sunflower oil. Known processes can be used to obtain fatty acids from vegetable oils.

Steryl esters of the invention can be produced by many known esterification procedures, however, transesterification, in which the alcohol moiety from a fatty acid ester, e.g., a fatty acid methyl ester, is displaced by another alcohol (in this case, free sterol) is preferred. Free sterol and a fatty acid methyl ester can be reacted in the presence of base catalysts such as sodium hydroxide or sodium methoxide, an acid catalyst such as p-toluene sulfonic acid, metals such as BBr₃, Me₃SiI, Al₂O₃, Ti(OR)₄, DMAP, and n-BuLi, K t-butoxide, and enzymes such as lipases, esterases, and α-chymotrypsin. Preferably, the catalyst is food grade. Typically, free sterol is mixed with a molar excess of fatty acid esters (e.g., a 5 to 10% molar excess), and the mixture is heated until the sterols dissolve (approximately 115 to 140° C.) before addition of catalyst. The reaction can be stirred and heated under vacuum until completion, during which time methanol produced from the reaction can be condensed and collected. Alternatively, free sterols and free fatty acids can be directly esterified according to the methods described, for example, in U.S. Pat. No. 5,892,068.

Fatty acid methyl esters can be produced by either esterifying free fatty acids with methanol or transesterifying triacylglycerols with methanol. Such reactions can be performed batchwise or continuously. For example, batch transesterification of triacylglycerols with methanol can be performed with an excess of methanol and in the presence of a catalyst, e.g., an alkaline catalyst, under high pressure (9000 kPa) and high temperature (˜240° C.). See, Bailey's Industrial Oil & Fat Products: General Applications, Vol. 5, pp. 49-53, John Wiley & Sons, Inc., New York, N.Y. (1996). Similar conditions are used for continuous transesterification.

Steryl esters can be purified by solvent or aqueous extraction, bleaching and deodorization, or other known methods. For example, purified steryl esters can be obtained by aqueous extraction by suspending the reaction products in aqueous sodium bicarbonate (e.g., 1%), filtering the suspension to obtain purified steryl esters, and drying the purified steryl esters. Reaction products can be bleached using diatomaceous earth, bleaching clay, activated carbon, silica, or combinations thereof. Purity of the steryl esters can be assessed by thin layer chromatography, gas chromatography (GC), or liquid chromatography (LC). LC is particularly useful.

Characterizing Steryl Esters

Steryl esters of the invention have a melting point that ranges from about 17° C. to about 35° C., as determined by differential scanning calorimetry (DSC). For example, the DSC melting point can be about 25-35° C. Melting points also can be determined by other techniques, including Mettler Drop Point and visual inspection of material in a capillary tube in a water or oil bath.

Steryl esters of the invention also can be characterized by solubility in lipids. Typically solubility is determined by methods known in the art. As described herein, steryl esters of the invention have enhanced oil solubility relative to steryl esters, where the ester moiety is a blend of fatty acids with less than 80% oleic acid.

Steryl Ester Compositions

Steryl esters of the invention can be formulated with one or more additives and used, for example, in cholesterol reducing compositions, reduced fat food compositions, confectionary products, as well as many other food products. Steryl esters can be about 1 to 99 weight percent (wt %) of such compositions, e.g., at least 10 wt % or at least 50 wt %. Additives are present in amounts totaling from about 0.01% to about 95 wt %, e.g., 0.1 to 90 wt %, 1.0 to 30 wt %, 5 to 20 wt %, 10 to 80 wt %, 20 to 60 wt %, 30 to 50 wt %, or 35 to 45 wt %, and can include, without limitation, sugars, flavorings, milk solids, emulsifiers, chelating agents (e.g., EDTA), surfactants (e.g., polyoxyethylene sorbitan monolaureate, polyoxyethylene sorbitan monopalmitate, polyoxyethylene sorbitan monooleate, or sodium lauryl sulfate), antioxidants (e.g., tocopherols, retinols, carotenes, butylated hydroxyanisole, or butylated hydroxytoluene), antifoam agents (e.g., simethicone), bulking agents, coloring agents, and preservatives. Specific formulations will vary depending on the end use; suitability of a specific formulation for a particular use can be assessed using standard techniques. For example, confectionary products containing steryl esters of the invention can be assessed for texture, palatability, and mouthfeel using a panel of trained taste testers.

Confectionery products of the invention include steryl ester compounds as at least a portion of the fat component. The term “fat component” as used herein refers to a fat or an oil. Steryl esters can be used to replace or extend a fat such as cocoa butter in confectionery products, e.g., chocolate or other food products. Steryl esters of the invention can be used as a cocoa butter substitute, at least in part due to the high monounsaturated fatty acid content and the melting profile. For example, a steryl ester can replace about 10% to about 100% (i.e., 10, 11, 12, 13, 14, 15, 20, 25, 50, 75, 85, 95, 96, 97, 98, 99, or 100%) of the cocoa butter in a confectionery product. A confectionary product also can contain, for example, sugars (e.g., sucrose, fructose, glucose, and maltose), water, flavorings such as cocoa powder, chocolate liquor, cocoa mass, vanilla, nut flavorings, fruit flavorings, and milk solids (non-fat, skimmed, or whole). In addition, a confectionery product can contain emulsifiers such as lecithin, synthetic phospholipids, and sorbitan esters to either improve rheological properties or crystallization. Antioxidants, dietary fibers, vitamins, bulking or bodying agents such as polydextrose or modified starch, and salt also can be included.

A confectionery product can be prepared by replacing at least a portion of the cocoa butter component of a standard formulation with a fat component provided herein using standard methods. See, for example, Minifie, B. W., Chocolate, Cocoa and Confectionery, 3rd Ed., Van Nostrand Reinhold, New York, 1989, pp 1-33; and Lees, R., A Course in Confectionery, 2nd Ed., Specialised Publications Ltd., Surrey, United Kingdom, 1980, pp. 98-106.

Other compositions containing steryl ester compounds can be prepared as suspensions, water dispersible powders, or tablets using known techniques. For example, spray drying and freeze drying techniques can be used to obtain powdered steryl ester compounds. See, for example, U.S. Pat. No. 3,881,005.

The invention will be further described in the following examples, which do not limit the scope of the invention described in the claims.

### EXAMPLES

### Example 1

Fatty acid methyl ester (FAME) synthesis: Oleic acid (200 g; 90% pure) or fatty acids from Clear Valley 75 (CV 75) canola oil (Cargill, Inc.) and methanol (113 g) were stirred in a round bottom flask. SOCl₂ (101 g) was added dropwise to the round bottom flask while keeping the flask cooled to room temperature. The mixture was stirred for 3 hours at room temperature, during which time the reaction was monitored by thin layer chromatography. After completion of the reaction, the mixture was washed with 1L of 5% NaHCO₃ in several portions then washed again with 1L of water in several portions. The washed reaction mixture then was dried under a vacuum. The dried mixture was distilled under vacuum to recover FAME (177 g). The fatty acid profile of the FAME product was analyzed by gas chromatography (GC) and compared to the GC analysis of the starting material oleic acid.

### Example 2

Steryl ester synthesis, purification, and analysis: Soy sterols or tall oil sterols (210 g) and the FAME product of Example 1 (165 g) were combined in a 1L round bottom flask. The mixture was heated to 120° C., under vacuum, to melt the sterols. After heating, NaOMe (0.4 g) was added and the mixture was held under a 0.5 mmHg vacuum while rotating at 120° C. for 3.5 hours during which time methanol produced from the reaction was condensed and collected. After completion of the reaction, the vacuum was broken and the crude material was washed with 40 mL of water to quench the catalyst. The washed material contained 400 g of crude steryl esters, which were stored at 4° C.

The crude steryl esters (400 g) were melted by heating to 100° C. and bleached as follows. The melted esters were added to a bleacher and dried at 100° C. under reduced pressure before addition of trysil (0.5 wt %) and diatomaceous earth (DE) (5 g). After stirring the mixture for 15 minutes at 87° C. under reduced pressure, the steryl esters were vacuum filtered through Whatman 4 filter paper. The resulting filtered esters then were charged back into the reaction flask with carbon (0.5 wt %), bleaching clay (2 wt %), and DE (3 g). After stirring the mixture for 30 minutes at 110° C. under reduced pressure, the steryl esters were filtered again and deodorized by heating to 500° F. under 0.5-1 mmHg with steam added at a rate of 0.04 mL/min for 45 minutes. After deodorizing, 275 g of purified steryl esters were collected.

The purified steryl esters were analyzed by GC, LC, and DSC. DSC melting profiles were obtained by holding the sample for 1 min at 20° C., then cooling the sample from 20° C. to −30° C. at a rate of 10° C./min. The sample was held at −30° C. for 3 min then heated to 90° C. at a rate of 10° C./min. Upon reaching 90° C., the sample was cooled to −30° C. at a rate of 10° C./min and held at −30° C. for 3 min before recording a final DSC scan as the sample was heated to 90° C. at a rate of 10° C./min.

Table 1 provides the fatty acid composition of the starting materials (free fatty acids (FFA) and fatty acid methyl esters (FAME)) and steryl esters, as well as the DSC melting profile. In Table 1, “SE” refers to steryl ester, “% monos” refers to the percentage of monounsaturated fatty acids, and “% polys” refers to the percentage of polyunsaturated fatty acids.

TABLE 1
Fatty Acid Profile of Starting Materials and Steryl Esters

| | | | | | | | DSC | | DSC |
|---|---|---|---|---|---|---|---|---|---|
| | % | % | % | % | % | DSC MP1 | dH1 | DSC | dH2 |
| | Oleate | Saturates | Monos | Polys | Sterols | (° C.) | (J/g) | MP2(° C.) | (J/g) |
| FFA Source | 87% | 5.25% | | | | | | | |
| FAME | 86.80% | 4.36% | 89.95% | 5.45% | | | | | |
| Soy steryl | | | | | 0.50% | 32.37 | 23.67 | 23.37 | 52.07 |
| oleate | | | | | | | | | |
| Tall oil | | | | | 2.03% | 29.2 | 24.53 | 24.53 | 49.87 |
| steryl oleate | | | | | | | | | |
| Stanol | | | | | 0.31% | 43.7 | 39.37 | 39.37 | 57.69 |
| oleate | | | | | | | | | |
| CV 75 | 69.62% | 7.60% | 75.08% | 16.92% | 1.99% | * | | | |
| steryl oleate | | | | | | | | | |
| Natural | | | | | | 32.12- | | | |
| cocoa butter | | | | | | 40.22 | | | |

The onset of melting for soy steryl oleate was 17.38° C., and was complete at 34.51° C. The onset of melting for tall oil steryl oleate was 17.63° C. and was complete at 27.65° C. The DSC melting point for natural cocoa butter ranged from 32.12° C. to 40.22° C.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A composition comprising a steryl ester, wherein the sterol moiety of said steryl ester is a phytosterol and the ester moiety of said steryl ester comprises a blend of fatty acids, wherein said blend of fatty acids comprises at least 80% oleic acid.

2. The composition of claim 1, wherein said phytosterol is a soy sterol.

3. The composition of claim 1, wherein phytosterol is a tall oil sterol.

4. The composition of claim 1, wherein said composition further comprises one or more components selected from the group consisting of sugar, flavorings, milk solids, emulsifiers, antioxidants, bulking agents, coloring agents, and preservatives.

5. The composition of claim 1, wherein said steryl ester has a DSC melting point of about 17° C. to about 35° C.

6. The composition of claim 1, wherein said steryl ester has a DSC melting point of about 25° C. to about 35° C.

7. The composition of claim 1, wherein said steryl ester comprises at least about 1 wt % of said composition.

8. The composition of claim 1, wherein said steryl ester comprises at least about 50 wt % of said composition.

9. The composition of claim 1, wherein the blend of fatty acids comprises 80 to 95% oleic acid.

10. A confectionary product comprising a fat component, wherein said fat component comprises a steryl ester, wherein the sterol moiety of said steryl ester is a phytosterol and the ester moiety of said steryl ester comprises a blend of fatty acids, wherein said blend of fatty acids comprises at least 80% oleic acid.

11. The confectionary product of claim 10, wherein said confectionary product further comprises one or more components selected from the group consisting of sugar, flavorings, milk solids, emulsifiers, antioxidants, bulking agents, coloring agents, and preservatives.

12. The confectionary product of claim 11, wherein said flavorings are selected from the group consisting of cocoa powder, cocoa mass, chocolate liquor, and vanilla.

13. The confectionary product of claim 11, wherein said emulsifiers are selected from the group consisting of lecithin, synthetic phospholipids, and sorbitan esters.

14. A method for producing a steryl ester, said method comprising esterifying a blend of fatty acids, or fatty acid esters, and a phytosterol to produce said steryl ester, wherein said blend of fatty acids or fatty acid esters comprises at least 80% oleic acid.

15. The method of claim 14, wherein said sterol is a soy sterol.

16. The method of claim 14, wherein said fatty acid esters are fatty acid methyl esters.

17. The method of claim 14 wherein the blend of fatty acids or fatty acid esters comprises 80 to 95% oleic acid.

18. The method of claim 14 wherein the blend of fatty acids or fatty acid esters comprises 90 to 95% oleic acid.

19. The method of claim 14 wherein: the sterol is a soy sterol; the fatty acid esters are fatty acid methyl esters, and the blend of fatty acids or fatty acid esters comprises 90 to 95% oleic acid.

20. The method of claim 14 wherein the steryl esters have a has a DSC melting point of about 17° C. to about 35° C.
